(19) United States
(12) Patent Application Publication
(10) Pub. No.: US 2022/0398524 A1
(43) Pub. Date: Dec. 15, 2022

(54) CONSUMER INTERACTION AGENT MANAGEMENT PLATFORM

(71) Applicant: Aktify, Inc., Lehi, UT (US)

(72) Inventors: Amir Ali Abdullah, Provo, UT (US); Jason Feriante, Bluffdale, UT (US); Cassandra Darley, Cedar Hills, UT (US); Ashley M. Wilson, Durham, NC (US); Kreg Peeler, Draper, UT (US)

(21) Appl. No.: 17/346,069

(22) Filed: Jun. 11, 2021

(51) Int. Cl. G06Q 10/06; G06F 40/226; G06F 40/35

(52) U.S. Cl. CPC G06Q 10/06395; G06Q 10/06375; G06F 40/226; G06F 40/35

(57) ABSTRACT

A consumer interaction agent management platform can be provided to facilitate the management of consumer interaction agents. The consumer interaction agent management platform can enable an analyst to obtain a performance summary of a consumer interaction agent representing how accurately the consumer interaction agent predicts the intent of consumer interactions it receives. The consumer interaction agent management platform may also provide various mechanisms for automatically creating training data for a particular intent. The consumer interaction agent management platform may further provide a mechanism for visualizing the extent to which a word impacts the intent predicted for a phrase that includes the word.

### CROSS-REFERENCE TO RELATED APPLICATIONS

N/A

### BACKGROUND

A lead can be considered a contact, such as an individual or an organization, that has expressed interest in a product or service that a business offers. A lead could merely be contact information such as an email address or phone number, but may also include an individual's name, address or other personal/organization information, an identification of how an individual expressed interest (e.g., providing contact/personal information via a web-based form, signing up to receive periodic emails, calling a sales number, attending an event, etc.), communications the business may have had with the individual, etc. A business may generate leads itself (e.g., as it interacts with potential customers) or may obtain leads from other sources.

A business may use leads as part of a marketing or sales campaign to create new business. For example, sales representatives may use leads to contact individuals to see if the individuals are interested in purchasing any product or service that the business offers. These sales representatives may consider whatever information a lead includes to develop a strategy that may convince the individual to purchase the business's products or services. When such efforts are unproductive, a lead may be considered dead. Businesses typically accumulate a large number of dead leads over time.

Recently, efforts have been made to employ artificial intelligence to identify leads that are most likely to produce successful results. For example, some solutions may consider the information contained in leads to identify which leads exhibit characteristics of the ideal candidate for purchasing a business's products or services. In other words, such solutions would inform sales representatives which leads to prioritize, and then the sales representatives would use their own strategies to attempt to communicate with the respective individuals.

### BRIEF SUMMARY

The present invention extends to a consumer interaction agent platform by which an analyst can manage consumer interaction agents. The consumer interaction agent management platform can enable an analyst to obtain a performance summary of a consumer interaction agent representing how accurately the consumer interaction agent predicts the intent of consumer interactions it receives. The consumer interaction agent management platform may also provide various mechanisms for automatically creating training data for a particular intent. The consumer interaction agent management platform may further provide a mechanism for visualizing the extent to which a word impacts the intent predicted for a phrase that includes the word.

In some embodiments, the present invention may be implemented as a method for managing a consumer interaction agent. A consumer interaction agent management platform can receive a request for a performance summary of a consumer interaction agent. The consumer interaction agent management platform can access phrases that have been associated with intents that the consumer interaction agent predicts. The consumer interaction agent management platform can split the phrases into training data and testing data. The consumer interaction agent management platform can train, via a pseudo agent, a model employed by the consumer interaction agent using the training data. The consumer interaction agent management platform can test, via the pseudo agent, the model using the testing data. In response to the testing via the pseudo agent, the consumer interaction agent management platform can generate a performance summary that identifies an accuracy at which the model predicted the intents. The consumer interaction agent management platform can then present the performance summary to the analyst.

In some embodiments, the present invention may be implemented as computer storage media storing computer executable instructions which when executed implement a method for creating training data for a consumer interaction agent. A consumer interaction agent management platform may receive, from an analyst, a request to create training data for a first intent of a plurality of intents that a consumer interaction agent predicts. The consumer interaction agent management platform can generate a plurality of phrases for the first intent. The consumer interaction agent management platform can present the plurality of phrases to the analyst. The consumer interaction agent management platform can receive input from the analyst that selects a subset of the plurality of phrases as matching the first intent. The consumer interaction agent management platform can add the subset of the plurality of phrases to training data for the consumer interaction agent.

In some embodiments, the present invention may be implemented as a lead management platform that includes one or more processors and computer storage media storing a consumer interaction agent management platform that is configured to generate a performance summary for a consumer interaction agent. The performance summary includes an accuracy at which a model employed by the consumer interaction agent predicts a plurality of intents and a confounding intent for at least one of the intents. The consumer interaction agent management platform that is also configured to create new training data for a first intent of the plurality of intents by generating a plurality of phrases for the first intent, presenting the plurality of phrases to the analyst, receiving input from the analyst that selects a subset of the plurality of phrases as matching the first intent and adding the subset of the plurality of phrases to training data for the consumer interaction agent.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which one or more embodiments of the present invention may be implemented;

FIG. 2 provides an example of various components that a lead management system may include in accordance with one or more embodiments of the present invention;

FIG. 3 provides an example of how a consumer interaction agent management platform may be configured in one or more embodiments of the present invention;

FIGS. 4A-4C provide examples of various data structures that may be used in one or more embodiments of the present invention;

FIG. 5 provides an example of how a consumer interaction agent management platform may generate and present a performance summary for a consumer interaction agent in one or more embodiments of the present invention;

FIGS. 6A-6C provide an example of how a consumer interaction agent management platform may create new training data in one or more embodiments of the present invention;

FIGS. 7A and 7B provide another example of how a consumer interaction agent management platform may create new training data in one or more embodiments of the present invention; and

FIG. 8 provides another example of how a consumer interaction agent management platform may generate and visualize attributions of words when an intent is predicted for a phrase that includes the words.

### DETAILED DESCRIPTION

In the specification and the claims, the term “consumer” should be construed as an individual. A consumer may or may not be associated with an organization. The term “lead” should be construed as information about, or that is associated with, a particular consumer. The term “consumer computing device” can represent any computing device that a consumer may use and by which a lead management system may communicate with the consumer. In a typical example, a consumer computing device may be a consumer's phone.

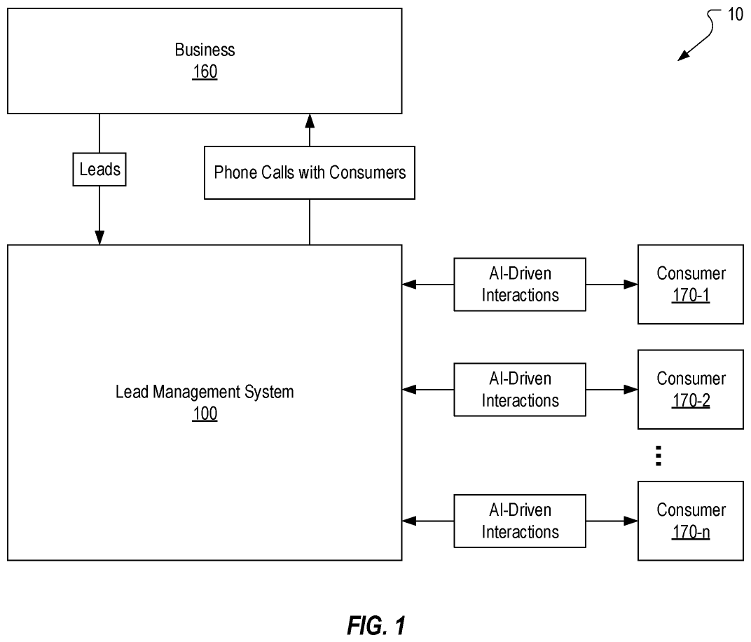

FIG. 1 provides an example of a computing environment 10 in which embodiments of the present invention may be implemented. Computing environment 10 may include a lead management system 100, a business 160 and consumers 170-1 through 170-n (or consumer(s) 170). As shown, business 160 can provide leads, in the form of raw lead data, to lead management system 100 where the leads can correspond with consumers 170. Typically, these leads may be dead leads that business 160 has accumulated, but any type of lead may be provided in embodiments of the present invention. Although only a single business 160 is shown, there may typically be many businesses 160.

Lead management system 100 can perform a variety of functionality on the leads to enable lead management system 100 to have AI-driven interactions with consumers 170. For example, these AI-driven interactions can be text messages that are intended to convince consumers 170 to have a phone call with a sales representative of business 160. Once the AI-driven interactions with a particular consumer 170 are successful (e.g., when the particular consumer 170 agrees to a phone call with business 160), lead management system 100 may initiate/connect a phone call between the particular consumer 170 and a sales representative of business 160. Accordingly, by only providing its leads, including its dead leads, to lead management system 100, business 160 can obtain phone calls with consumers 170.

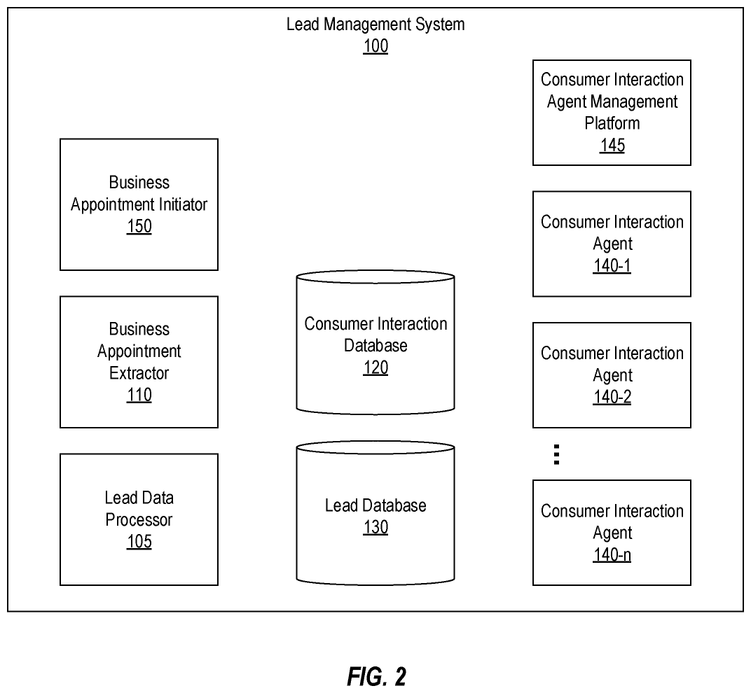

FIG. 2 provides an example of various components that lead management system 100 may include in one or more embodiments of the present invention. These components may include a lead data processor 105, a business appointment extractor 110, a consumer interaction database 120, a lead database 130, consumer interaction agents 140-1 through 140-n (or consumer interaction agent(s) 140), a consumer interaction agent management platform 145 and a business appointment initiator 150.

Lead data processor 105 can represent one or more components of lead management system 100 that process the leads received from business 160 (e.g., the raw lead data received from business 160) to generate lead processing result objects. These lead processing result objects may be stored in lead database 130. As described in U.S. patent application Ser. No. 17/346,055 which is incorporated by reference, these lead processing result objects are configured to facilitate and maximize the efficiency and accuracy of AI-driven interactions that lead management system 100 may have with the corresponding consumers.

Business appointment extractor 110 can represent one or more components of lead management system 100 that implement a scheduling language and model for extracting appointments from consumer interactions. Consumer interaction database 120 can represent one or more data storage mechanisms for storing consumer interactions or data structures defining consumer interactions.

Consumer interaction agents 140 can be configured to interact with consumers 170 via consumer computing devices. For example, consumer interaction agents 140 can communicate with consumers 170 via text messages, emails or another text-based mechanism. These interactions, such as text messages, can be stored in consumer interaction database 120 and associated with the respective consumer 170 (e.g., via associations with the corresponding lead defined in lead database 130). Consumer interaction agents 140 can employ the lead processing result objects to dynamically determine the timing and content of these interactions.

Consumer interaction agent management platform 145 can represent one or more components of lead management system 100 that are configured to enable analysts to monitor, audit and train consumer interaction agents 140 to enhance their abilities to have effective AI-driven interactions with consumers 170. In some embodiments, consumer interaction agent management platform 145 may include a user interface by which analysts may interact with consumer interaction agent management platform 145 and an API by which consumer interaction agent management platform 145 interfaces with consumer interaction agents 140. Consumer interaction agent management platform 145 can be configured to implement a variety of machine learning techniques to assist analysts in testing and improving the performance of consumer interaction agents 140.

Business appointment initiator 150 can represent one or more components of lead management system 100 that are configured to initiate an appointment (e.g., a phone call or similar communication) between a consumer 170 and a representative of business 160. For example, business appointment initiator 150 could establish a call with a consumer and then connect the business representative to the call. In some embodiments, business appointment extractor 110 can intelligently select the timing of such appointments by applying a scheduling language and model to the consumer interactions that consumer interaction agents 140 have with consumers 170 as is described in U.S. patent application Ser. No. 17/346,032, which is incorporated by reference.

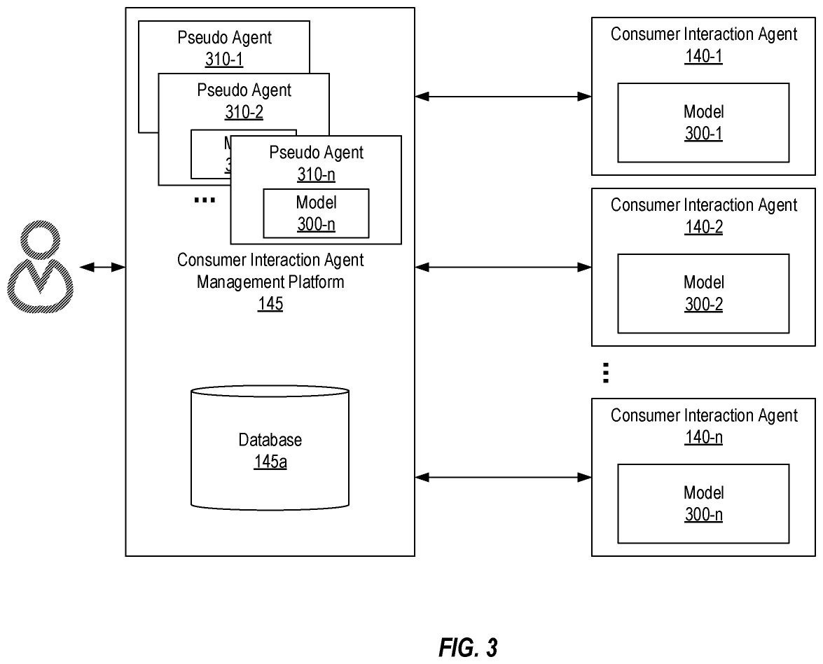

FIG. 3 provides an overview of how consumer interaction agent management platform 145 may be used in one or more embodiments of the present invention. As shown, each of consumer interaction agents 140-1 through 140-n can include a model 300-1 through 300-n respectively (or model(s) 300) by which the agent can predict the intent of a consumer interaction (i.e., to assign a classifier to a consumer interaction) and use the predicted intent to select a response. For example, when a consumer interaction agent 140 is exchanging text messages with a consumer 170, consumer interaction action 140 can apply model 300 to a text message to predict consumer 170's intent from the content of the text message and then use the predicted intent to select the content for a responsive text message.

To train and tune consumer interaction agents 140 to more effectively identify intents and generate appropriate responses, an analyst can employ consumer interaction agent management platform 145. Consumer interaction agent management platform 145 may include a database 145a for storing a variety of data such as training data, responses, consumer interactions (e.g., raw text messages), performance summary data, etc. Although database 145a will be described as storing such data in the form of tables, any suitable data storage mechanism and/or format can be used. Consumer interaction agent management platform 145 may also include pseudo agents 310-1 through 310-n (or pseudo agent(s) 310) which correspond with consumer interaction agents 140-1 through 140-n respectively. Each pseudo agent 310 can include a model 300 for predicting intents and can therefore be used to test, evaluate, tune, etc. the corresponding consumer interaction agent 140.

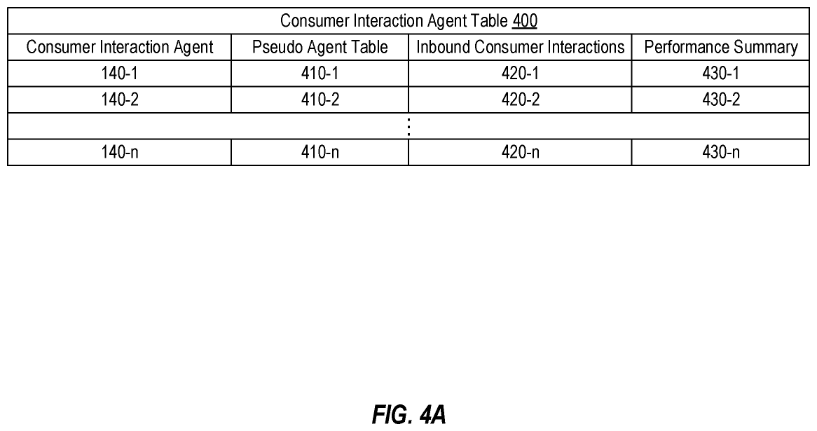

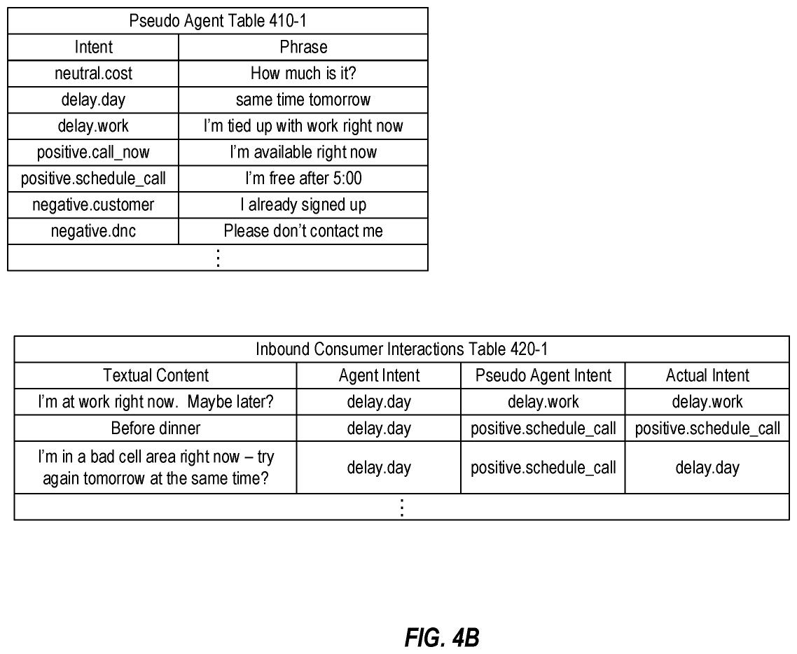

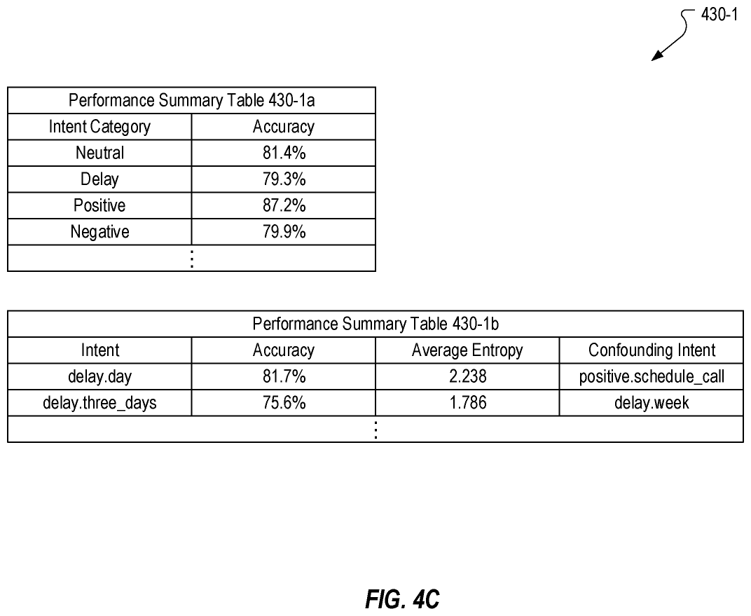

FIGS. 4A-4C provide examples of data structures that consumer interaction agent management platform 145 may generate and store in database 145a as part of performing the functionality described below. In FIG. 4A, a consumer interaction agent table 400 is shown which can identify each consumer interaction agent 140 and its associated pseudo agent table, inbound consumer interaction table and performance summary table(s). In other words, consumer interaction agent management platform 145 may maintain a set of these tables for each consumer interaction agent 140. Tables are used as an example only and any suitable data structure could be used in embodiments of the present invention.

FIG. 4B provides an example of a pseudo agent table 410-1 which may be maintained for consumer interaction agent 140-1. Pseudo agent table 410-1 may include the training data for consumer interaction agent 140-1. In particular, pseudo agent table 410-1 can include phrases and the defined intents that are used to train model 300-1. This training data could have come from any source including from consumer interactions that consumer interaction agent 140-1 has had and manual input. FIGS. 4B also provides an example of an inbound consumer interactions table 420-1 which may be maintained for consumer interaction agent 140-1. Inbound consumer interactions table 420-1 may include the textual content of inbound consumer interactions that consumer interaction agent 140-1 has received, an intent that consumer interaction agent 140-1 predicted for the textual content, an intent that the corresponding pseudo agent 310-1 predicted for the textual content (if any) and the actual intent (i.e., the intent assigned by an analyst).

FIG. 4C provides an example of performance summary tables 430-1a and 430-1b for consumer interaction agent 140-1. Performance summary table 430-1a can identify an intent category (e.g., neutral, delay, positive and negative) and an accuracy at which model 300-1 that consumer interaction agent 140-1 employs predicted intents in the intent categories. Performance summary table 430-1b can identify the individual intents, an accuracy at which model 300-1 that consumer interaction agent 140-1 employs predicted each intent, an average entropy for each intent and a confounding intent for each intent (i.e., the most frequently predicted wrong intent).

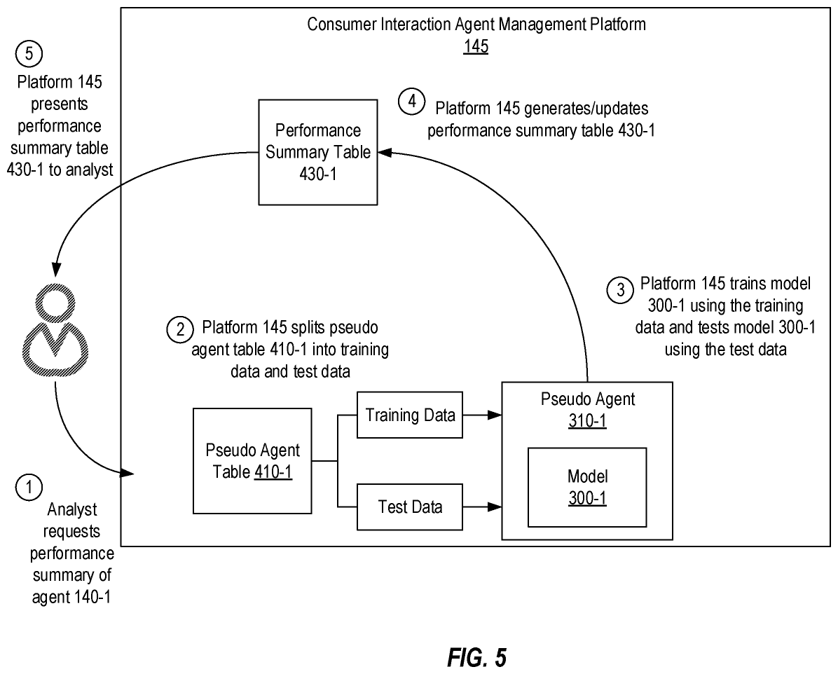

FIG. 5 provides an example of how consumer interaction agent management platform 145 can enable an analyst to evaluate the performance of a consumer interaction agent 140, or more particularly, the performance of a model 300 that consumer interaction agent 140 employs. Notably, this analysis can be performed using the respective pseudo agent 310 while consumer interaction agent 140 remains active and therefore enables the analyst to tune the performance of the respective model 300 without impacting consumer interaction agent 140's performance.

As represented as step 1, an analyst can interface with consumer interaction agent management platform 145 to request a performance summary of consumer interaction agent 140-1. For purposes of this example, it can be assumed that consumer interaction agent 140-1 has been deployed to communicate via text messages with a particular business 160's leads. Accordingly, the analyst may submit this request to determine how well consumer interaction agent 140-1 may be predicting the intent of text messages sent by such leads.

In response to the analyst's request, consumer interaction agent management platform 145 can access consumer interaction agent table 400 to determine that pseudo agent table 410-1 corresponds with consumer interaction agent 140-1. Then, in step 2, consumer interaction agent management platform 145 can access pseudo agent table 410-1 and split its content into training data and test data. For example, 80% of the phrases can be used as training data and 20% of the phrases can be used as test data. In step 3, consumer interaction agent management platform 145 can use the training data to train model 300-1 implemented by pseudo agent 310-1 and can then use the test data to test model 300-1.

In step 4, consumer interaction agent management platform 145 can then use the results of training and testing model 300-1 to generate/update performance summary table 430-1. For example, for each intent that is predicted for the phrases in the test data, consumer interaction agent management platform 145 can determine whether the intent is correct (e.g., by comparing the predicted intent to the intent assigned to the phrase in pseudo agent table 410-1). With such information, consumer interaction agent management platform 145 can calculate an accuracy for each intent category as well as a per-intent accuracy and entropy such as is shown in FIG. 4C. Additionally, consumer interaction agent management platform 145 may identify one or more confounding intents for each intent. For example, with reference to FIG. 4C, consumer interaction agent management platform 145 could determine that, when model 300-1 failed to correctly predict the delay.day intent, it most often predicted the positive.schedule_call intent.

In step 5, consumer interaction agent management platform 145 may present performance summary table 430-1 to the analyst to enable the analyst to determine how to improve the performance of consumer interaction agent 140-1. For example, by determining a confounding intent, consumer interaction agent management platform 145 can assist the analyst in determining what type of training data may be most beneficial in assisting model 300-1 to correctly predict the respective intent. As one example, again with reference to FIG. 4C, consumer interaction agent management platform 145 could determine that more training data should be generated/obtained for the delay.three_days and delay.week intents to assist model 300-1 in predicting the delay.three_days intent at an accuracy greater than 75.6% (i.e., to minimize the frequency at which model 300-1 predicts the delay.week intent when the delay.three_days intent should be predicted).

In some embodiments, consumer interaction agent management platform 145 may use the intents predicted by pseudo agent 310-1 using model 300-1 to populate the pseudo agent intent column of inbound consumer interactions table 420-1 in step 4. For example, if pseudo agent table 410-1 includes the same phrases as inbound consumer interactions table 420-1, consumer interaction agent management platform 145 can match up the intents predicted by consumer interaction agent 140-1 and pseudo agent 310-1 to allow the analyst to compare the agents' respective performance on a per-phase basis. In this way, the analyst can determine whether the configuration of model 300-1 that pseudo agent 310-1 employs is performing better than the configuration of model 300-1 that consumer interaction agent 300-1 is currently employing to communicate with consumers. In such cases, consumer interaction agent management platform 145 may present inbound consumer interactions table 420-1 to the analyst as part of step 5.

After reviewing performance summary table 430-1 and/or consumer interactions table 420-1, the analyst may take a number of actions. For example, the analyst could determine that the configuration of model 300-1 employed by pseudo agent 310-1 performed better than the configuration of model 300-1 employed by consumer interaction agent 140-1, and in response, could instruct consumer interaction agent management platform 145 to replace/update consumer interaction agent 140-1 with pseudo agent 310-1. In other words, consumer interaction agent management platform 145 can cause the configuration of model 300-1 employed by pseudo agent 310-1 to be deployed to consumer interaction agent 140-1 to predict intents of inbound consumer interactions.

As another example, an analyst could determine that more training data for a particular intent is needed. In some embodiments, consumer interaction agent management platform 145 may provide mechanisms by which the analyst can automatically create such training data. These mechanisms may be used at any time and not merely in response to reviewing an agent's performance.

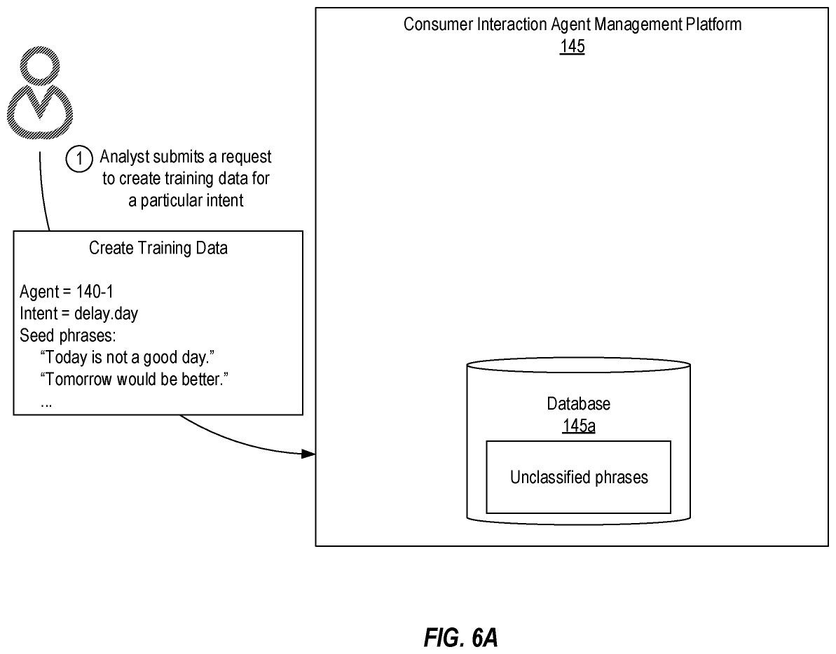

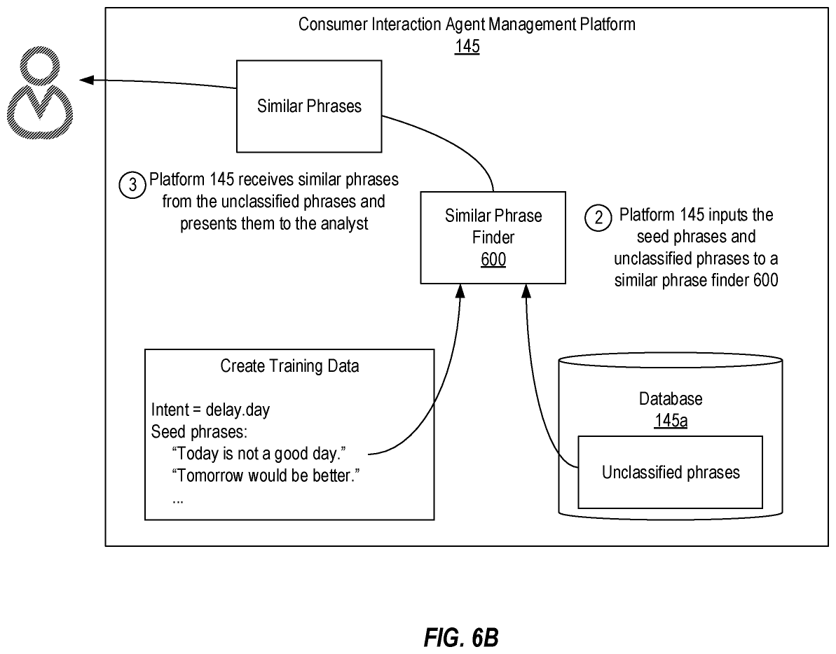

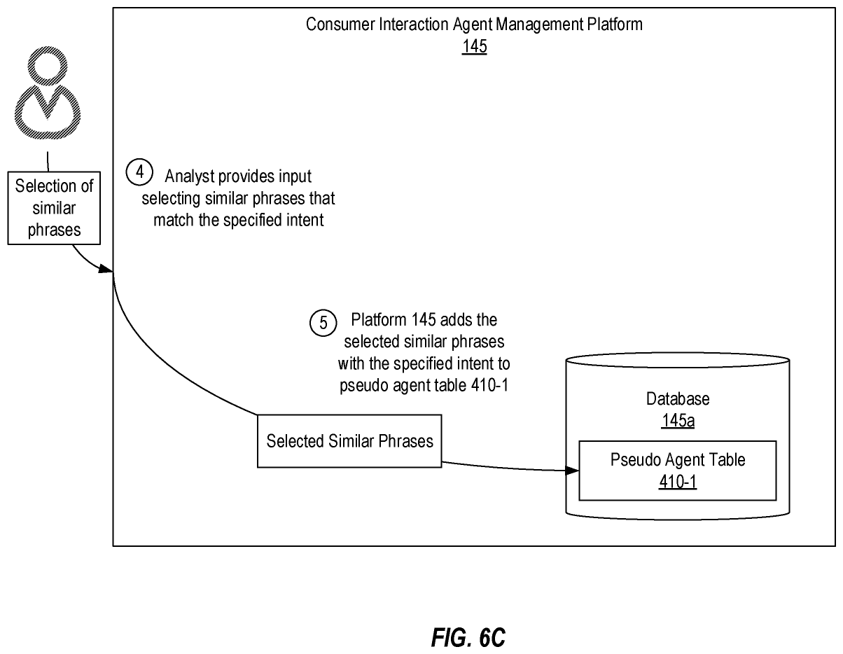

FIGS. 6A-6C provide an example of how consumer interaction agent management platform 145 may enable an analyst to create new training data for a particular intent. In step 1 shown in FIG. 6A, it is assumed that an analyst has submitted to consumer interaction agent management platform 145 a request to create training data for a particular intent, which in this case is the delay.day intent. In this request, the analyst can also specify a number of seed phrases that the analyst has manually created or obtained that match the particular intent.

Turning to FIG. 6B, in step 2, consumer interaction agent management platform 145 can obtain unclassified phrases from database 145a (or any other source) and the seed phrases specified in the request to create training data and input them to a similar phrase finder 600. In some embodiments, the unclassified phrases could be incoming consumer interactions that any of agents 140 may have had. Similar phrase finder 600 can perform any suitable technique to determine which of the unclassified phrases match the seed phrases. As one example, similar phrase finder 600 could create/maintain an index of text embeddings of the unclassified phrases. In such cases, similar phrase finder 600 may convert the seed phrases into numeric representations that can be used to search the index for the closest match (e.g., using a nearest neighbor algorithm). The phrases corresponding to such matches could then be output as similar phrases. Regardless of the specific technique that consumer interaction agent management platform 145 may employ to identify phrases in the unclassified phrases that are similar to the seed phrases, in step 3, consumer interaction agent management platform 145 can present the similar phrases to the analyst.

Turning to FIG. 6C, the analyst can then review the similar phrases that consumer interaction agent management platform 145 has presented and select phrases that match the specified intent. In this example, the analyst could select, from among all of the phrases that were determined to be similar, those that have an intent of delay.day. In step 5, consumer interaction agent management platform 145 can add the selected phrases with the specified intent to pseudo agent table 410-1. In this way, consumer interaction agent management platform 145 can assist the analyst in quickly and efficiently creating new training data for a particular intent.

In some embodiments, consumer interaction agent management platform 145 may provide a model-based option for creating new training data for a specified intent that is similar to the process represented in FIGS. 6A-6C. In this model-based option, consumer interaction agent management platform 145 can train a model 300 with a data set that includes many more phrases classified with the specified intent than phrases classified with other intents (i.e., oversampling for the specified intent). The trained model can then be used to predict the intent for the unclassified phrases. Any phrase for which the specified intent is predicted can be presented to the analyst as a similar phrase as described above.

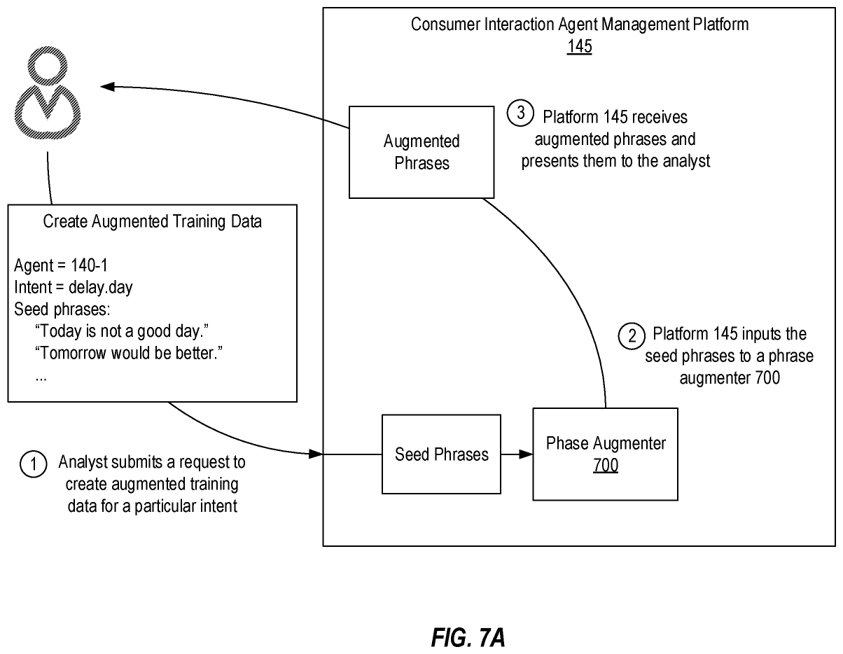

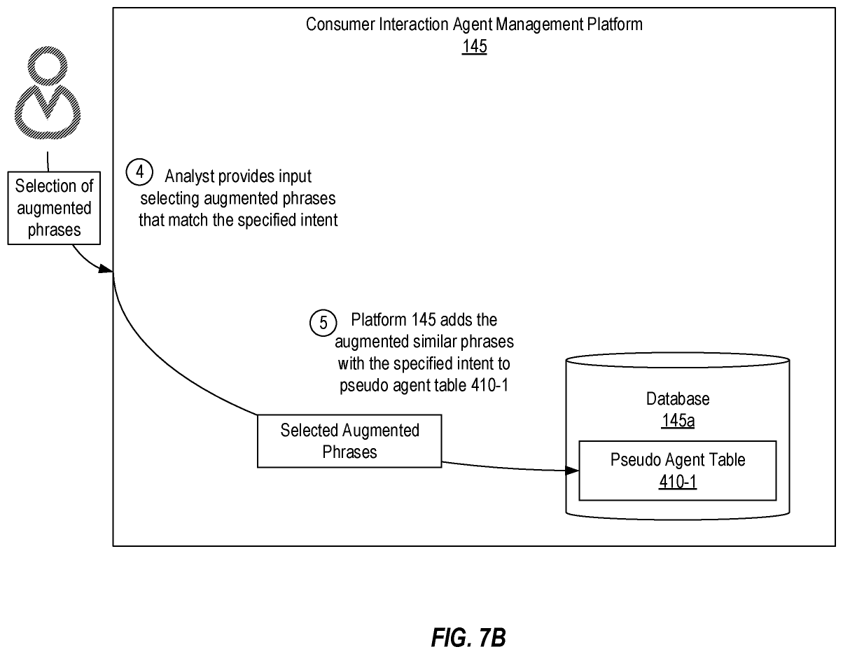

FIGS. 7A and 7B provide another example of how consumer interaction agent management platform 145 may enable an analyst to create new training data through augmentation of existing training data. In step 1, the analyst again submits a request to create training data which specifies an intent and includes a number of seed phrases. In step 2, consumer interaction agent management platform 145 can input the seed phrases to a phrase augmenter 700. Phrase augmenter 700 can be configured to apply one or more augmentations to the seed phrases to created augmented phrases. For example, phrase augmenter 700 could apply a tense augmentation (e.g., by changing the tense of verbs in the seed phrase), a negation augmentation (e.g., by negating a word in the seed phrase), a declarative augmentation (e.g., by converting the seed phrase into a declarative statement), an imperative augmentation (e.g., by converting the seed phrase into an imperative statement), a backtranslation augmentation (e.g., by translating the seed phrase to German and then translating back to English), and/or another augmentation. In step 3, consumer interaction agent management platform 145 can receive the augmented phrases and present them to the analyst.

Turning to FIG. 7B, in step 4, the analyst can select the augmented phrases that match the specified intent. Then, in step 5, consumer interaction agent management platform 145 can add the selected augmented phrases to pseudo agent table 410-1.

Notably, as the analyst uses the above-described techniques to add new training data to pseudo agent table 410-1, subsequent requests for a performance summary of consumer interaction agent 140-1 may reflect the added training data. In this way, the analyst can review how the addition of training data has impacted model 300-1's performance. In some embodiments, the analyst may iteratively perform the above-described techniques to maximize the efficiency and accuracy of model 300-1 and may then deploy it to consumer interaction agent 140-1.

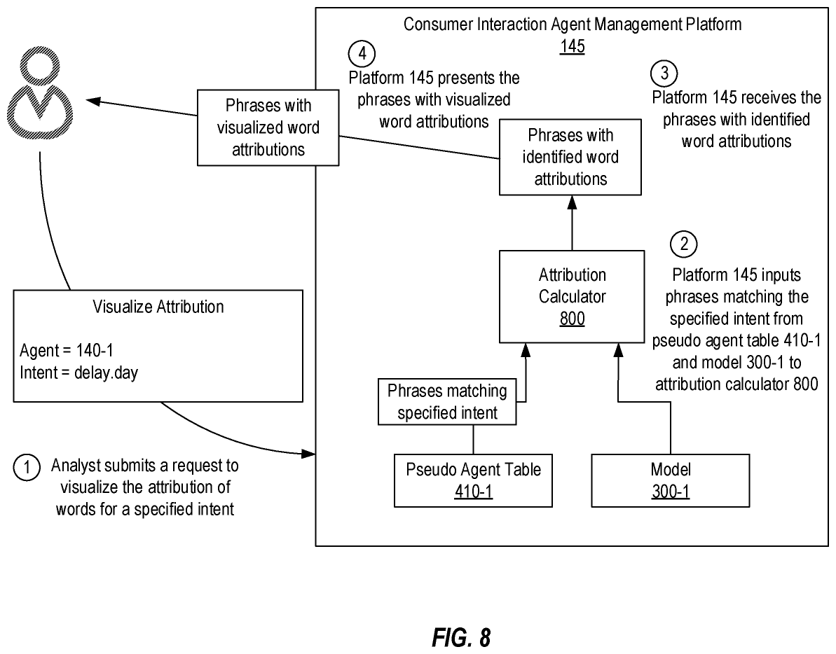

In some embodiments, consumer interaction agent management platform 145 may provide a mechanism by which an analyst can visualize the importance of each word in a set of phrases. FIG. 8 provides an example. In step 1, an analyst can submit a request to visualize the attribution of words when a particular consumer interaction agent 140 predicts an intent. In step 2, consumer interaction agent management platform 145 can retrieve phrases matching the specified intent from pseudo agent table 410-1 and input them along with model 300-1 to attribution calculator 800. In some embodiments, attribution calculator 800 may apply integrated gradients on model 300-1 to generate attribution for words which represent the extent to which the presence of the words in a phrase causes model 300-1 to predict the particular intent for that phrase. In step 3, consumer interaction agent management platform 145 can receive the phrases with the identified word attributions. In step 4, consumer interaction agent management platform 145 can present the phrases to the analyst with visual indicators representing the attributions. For example, a word that heavily impacts the predicted intent can be given one color while a word that has a lesser impact on the predicted intent can be given another color. With such visual indicators, the analyst may quickly identify whether model 300-1 should be adjusted to minimize the impact that such words may have on the predicted intent. As one example, the word “thanks” may appear so frequently in phrases for which the intent negative.not_interested is predicted (e.g., in the form of “no thanks” or “thanks, but . . . ”) that model 300 may predict this intent for any phrase with the word “thanks.” By presenting such words with visual indicators, consumer interaction agent management platform 145 can simplify the process of identifying and correcting such issues.

Consumer interaction agent management platform 145 may provide many other features and functionality to assist an analyst in managing, evaluating and improving consumer interaction agents 140. For example, consumer interaction agent management platform 145 can enable an analyst to copy intents or training data between agents, rebuild agents, deploy agents, etc. As a result, analysts can more efficiently create consumer interaction agents 140 that can accurately predict the intent of a consumer interaction.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similar storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for managing a consumer interaction agent, the method comprising:
receiving, from an analyst, a request for a performance summary of a consumer interaction agent;
accessing phrases that have been associated with intents that the consumer interaction agent predicts;
splitting the phrases into training data and testing data;
training, via a pseudo agent, a model employed by the consumer interaction agent using the training data;
testing, via the pseudo agent, the model using the testing data;
in response to the testing via the pseudo agent, generating a performance summary that identifies an accuracy at which the model predicted the intents; and
presenting the performance summary to the analyst.

2. The method of claim 1, wherein the performance summary also identifies an entropy of the intents.

3. The method of claim 1, wherein the performance summary also identifies a confounding intent for each of the intents.

4. The method of claim 1, wherein the performance summary also identifies an accuracy for a plurality of intent categories.

5. The method of claim 1, further comprising:
receiving, from the analyst, a request to create training data for a first intent of the intents, the request including seed phrases;
identifying, from unclassified phrases, similar phrases to the seed phrases; and
presenting the similar phrases to the analyst.

6. The method of claim 5, wherein the seed phrases are converted into numerical representations and the similar phrases are identified using a nearest neighbor algorithm.

7. The method of claim 5, further comprising:
receiving input from the analyst that selects a subset of the similar phrases as matching the first intent; and
adding the subset of the similar phrases to training data for the consumer interaction agent.

8. The method of claim 1, further comprising:
receiving, from the analyst, a request to create training data for a first intent of the intents;
training a model using an oversampling of phrases that match the first intent;
using the trained model to predict intents for unclassified phrases, including predicting the first intent for a set of the unclassified phrases; and
presenting to the analyst the set of unclassified phrases for which the first intent was predicted.

9. The method of claim 8, further comprising:
receiving input from the analyst that selects a subset of the set of unclassified phrases for which the first intent was predicted; and
adding the subset of the set of unclassified phrases for which the first intent was predicted to training data for the consumer interaction agent.

10. The method of claim 1, further comprising:
receiving, from the analyst, a request to create training data for a first intent of the intents, the request including seed phrases;
creating augmented phrases from the seed phrases; and
presenting the augmented phrases to the analyst.

11. The method of claim 10, further comprising:
receiving input from the analyst that selects a subset of the augmented phrases; and
adding the subset of the augmented phrases to training data for the consumer interaction agent.

12. The method of claim 1, further comprising:
receiving, from the analyst, a request to visualize attribution of words to a prediction of a first intent of the intents;
calculating, from phrases matching the first intent and the model, attributions of words in the phrases to the prediction of the first intent;
creating a visualization for the attributions; and
presenting the phrases to the analyst with the visualizations for the attributions.

13. The method of claim 1, further comprising:
after training the model, deploying the model to the consumer interaction agent for use in predicting intents of consumer interactions received by the consumer interaction agent.

14. The method of claim 1, further comprising:
in response to input from the analyst, copying one or more of the intents to a second consumer interaction agent.

15. One or more computer storage media storing computer executable instructions which when executed implement a method for creating training data for a consumer interaction agent, the method comprising:
receiving, from an analyst, a request to create training data for a first intent of a plurality of intents that a consumer interaction agent predicts;
generating a plurality of phrases for the first intent;
presenting the plurality of phrases to the analyst;
receiving input from the analyst that selects a subset of the plurality of phrases as matching the first intent; and
adding the subset of the plurality of phrases to training data for the consumer interaction agent.

16. The computer storage media of claim 15, wherein the request to create training data includes seed phrases, and wherein generating the plurality of phrases for the first intent comprises identifying similar phrases to the seed phrases from unclassified phrases.

17. The computer storage media of claim 15, wherein the request to create training data includes seed phrases, and wherein generating the plurality of phrases for the first intent comprises generating augmented phrases from the seed phrases.

18. The computer storage media of claim 15, wherein generating the plurality of phrases for the first intent comprises:
training a model using an oversampling of phrases that match the first intent;
using the trained model to predict intents for unclassified phrases such that the plurality of phrases are those for which the first intent was predicted.

19. The computer storage media of claim 15, wherein the method further comprises:
receiving, from the analyst, a request for a performance summary of the consumer interaction agent;
generating a performance summary that identifies an accuracy at which a model employed by the consumer interaction agent predicts each of the intents and a confounding intent for at least one of the intents; and
presenting the performance summary to the analyst.

20. A lead management platform comprising:
one or more processors; and
computer storage media storing a consumer interaction agent management platform that is configured to:
generate a performance summary for a consumer interaction agent, the performance summary including an accuracy at which a model employed by the consumer interaction agent predicts a plurality of intents and a confounding intent for at least one of the intents; and
create new training data for a first intent of the plurality of intents by generating a plurality of phrases for the first intent, presenting the plurality of phrases to the analyst, receiving input from the analyst that selects a subset of the plurality of phrases as matching the first intent and adding the subset of the plurality of phrases to training data for the consumer interaction agent.
